(19) United States
(12) Patent Application Publication
(10) Pub. No.: US 2026/0050000 A1
(43) Pub. Date: Feb. 19, 2026

(54) SAMPLE PROCESSING AND REGISTRATION SYSTEM AND METHOD

(71) Applicant: AZENTA, Inc., Burlington, MA (US)

(72) Inventors: Sean CANTRELL, Burlington, MA (US); Frank HUNT, Burlington, MA (US); Brent PALERMO, Burlington, MA (US); Mark SUN, Burlington, MA (US); Aaron PLAISTED, Burlington, MA (US); Marco PIETSCHMANN, Burlington, MA (US); Sascha MICHALKE, Burlington, MA (US)

(21) Appl. No.: 19/301,126

(22) Filed: Aug. 15, 2025

Related U.S. Application Data
(60) Provisional application No. 63/683,497, filed on Aug. 15, 2024.

(51) Int. Cl. G01N 35/00

(52) U.S. Cl. CPC G01N 35/00732; G01N 35/0099; G01N 2035/00346; G01N 2035/00752; G01N 2035/00831

(57) ABSTRACT

An automated sample registration system for registering samples disposed in sample containers or tubes, the system including: a sample container infeed store station having a holding location with a store array configured for storing the containers therein; a sample imager station, with a machine vision system having at least one of a line scanner and a camera, at least one of the line scanner and the camera being configured to generate a machine readable image of each container transported from the array with a transport device automatic grip, the container being held in the grip substantially continuously from container pick, at the store array, throughout imaging of the container by the machine vision system; wherein the grip holds the sample container substantially coincident, at least in part, with imaging of the container by the machine vision system so that generating the machine readable image is effected in one grip step.

### CROSS REFERENCE TO RELATED APPLICATIONS

This application is a non-provisional of and claims the benefit of U.S. Provisional Patent Application No. 63/683,497 filed on Aug. 15, 2024, the disclosure of which is incorporated by reference herein in its entirety.

### BACKGROUND

### 1. Field

The present disclosure generally relates to a system and method of processing samples, particularly an automated or semi-automated processing, pre-registering, and registering a large number of biological, chemical or biochemical samples at temperature.
2. Brief Description of Related Developments

Generally, sample containers, such as test tubes, are collected from various sources (e.g., clinics, hospitals, laboratories etc.) and labeled with patient information, test type, collection date and other data relevant to the sample. Some of these sample containers must be transported and stored at cold temperatures (e.g., −20, to −180° C.) in order to maintain the integrity of the sample. Upon receipt of samples for storage, lab technicians inspect the sample containers and compare the sample containers against a manifest, which includes checking the number of samples, patient details, test types, etc. In some systems, the sample containers are physically handled by the lab technicians and the data related to each sample container is manually entered or scanned to register the sample into the laboratories information management system. This multiple handling of the specimens is time-consuming, is subject to human error, and can result in the warming and degradation in the integrity of the sample.

Accordingly, the present disclosure addresses a number of those issues.

### BRIEF DESCRIPTION OF THE DRAWINGS

The foregoing aspects and other features of the present disclosure are explained in the following description, taken in connection with the accompanying drawings, wherein:

FIG. 1 is a schematic block diagram of a laboratory in accordance with the present disclosure;

FIG. 2 is an exemplary illustration of a sample container of the laboratory of FIG. 1 in accordance with the present disclosure;

FIGS. 3A-3B are exemplary illustrations of a sample trays of the laboratory of FIG. 1 in accordance with the present disclosure;

FIGS. 4A-4C are exemplary illustrations of a gripping tool of the laboratory of FIG. 1 in accordance with the present disclosure;

FIG. 5 is an exemplary illustration of a registration tool of the laboratory of FIG. 1 in accordance with the present disclosure;

FIG. 6 is another exemplary illustration of the registration tool of FIG. 5 in accordance with the present disclosure;

FIG. 7 is an exemplary illustration of a feature of the laboratory of FIG. 1 in accordance with the present disclosure;

FIG. 8 is an exemplary illustration of a feature of the laboratory of FIG. 1 in accordance with the present disclosure;

FIG. 9 is an exemplary illustration of a machine learning algorithm of the laboratory of FIG. 1 in accordance with the present disclosure;

FIG. 10 is an exemplary illustration of a register of the laboratory of FIG. 1 in accordance with the present disclosure;

FIG. 11 is an exemplary illustration of an automated accessioning system of the laboratory of FIG. 1 in accordance with the present disclosure;

FIG. 12 is an exemplary illustration of a portion of the automated accessioning system of FIG. 11 in accordance with the present disclosure;

FIG. 13 is an exemplary illustration of a portion of the automated accessioning system of FIG. 11 in accordance with the present disclosure;

FIG. 14 is an exemplary illustration of a graph in accordance with the present disclosure;

FIGS. 15A-15E are exemplary illustrations of a method of the laboratory of FIG. 1 in accordance with the present disclosure;

FIGS. 16A-16E are exemplary illustrations of a method of the laboratory of FIG. 1 in accordance with the present disclosure; and

FIG. 17 is an exemplary illustration of a method of the laboratory of FIG. 1 in accordance with the present disclosure.

### DETAILED DESCRIPTION

The following detailed description is meant to assist the understanding of one skilled in the art, and is not intended in any way to unduly limit claims connected or related to the present disclosure.

The following detailed description references various figures, where like reference numbers refer to like components and features across various figures, whether specific figures are referenced, or not.

The word “each” as used herein refers to a single object (i.e., the object) in the case of a single object or each object in the case of multiple objects. The words “a,” “an,” and “the” as used herein are inclusive of “at least one” and “one or more” so as not to limit the noun being referred to as being in its “singular” form.

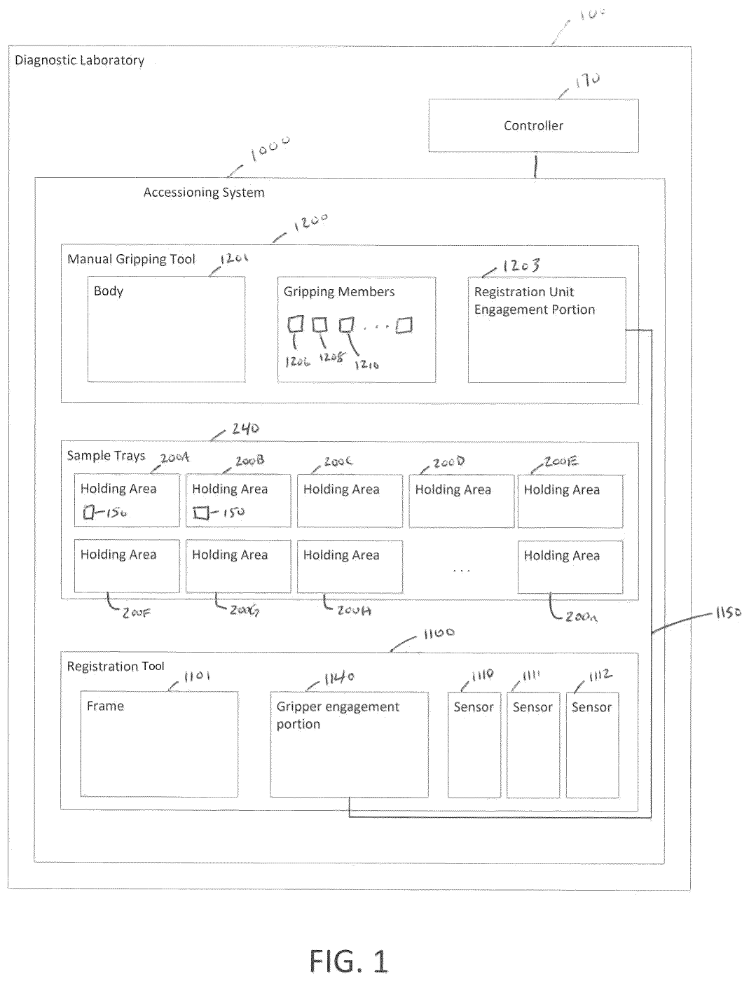

FIG. 1 is a schematic illustration of a portion of a laboratory 100 in accordance with an aspect of the disclosed embodiment. The disclosed embodiment provides a quick, one-touch (or one-step) registration of sample containers 150 incoming to the laboratory 100. Although the aspects of the disclosed embodiment will be described with reference to the drawings, it should be understood that the aspects of the disclosed embodiment can be embodied in many forms. In addition, any suitable size, shape or type of elements or materials could be used.

The present embodiment is directed to a system and method of processing samples, particularly an automated or semi-automated processing, pre-registering and registering of a large number of biological, chemical or biochemical samples at temperature. Upon receipt of the samples at a sample storage site, samples undergo an intake process to receive the sample, register the sample data, verify the sample data, and deposit the sample into a formatted storage tray. These samples may employ temperature controls to maintain samples at various temperatures from ambient to cold (−20° C.), ultra-cold (−80° C.), or cryogenic (−190° C.). Therefore, samples must be handled carefully and efficiently and tracked accurately so that samples can be stored and retrieved without compromising the sample integrity during intake and registration of the specimens. In addition, efficient and accurate collection and control of data transfer from the sample containers 150 into a register ensures overall increased sample integrity. The present embodiment is described as particularly directed to the intake, registering, recording, data auditing and storage of samples, such as blood, serum, urine, tissue, and the like while it is understood that the system and method of the present embodiment are applicable where other materials are subjected to collection and storage procedures. It is further understood that the system and method of the present embodiment are scalable depending on the volume of specimens to be handled through the system.

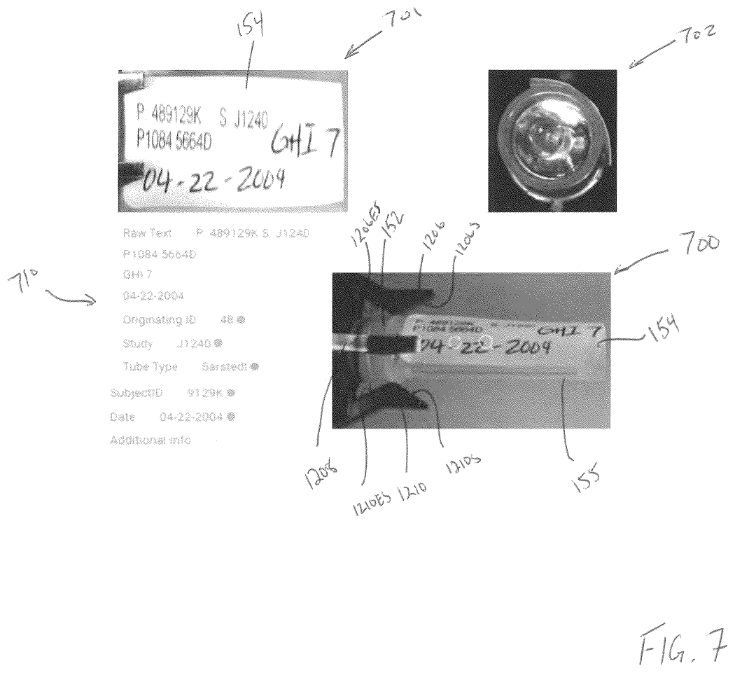

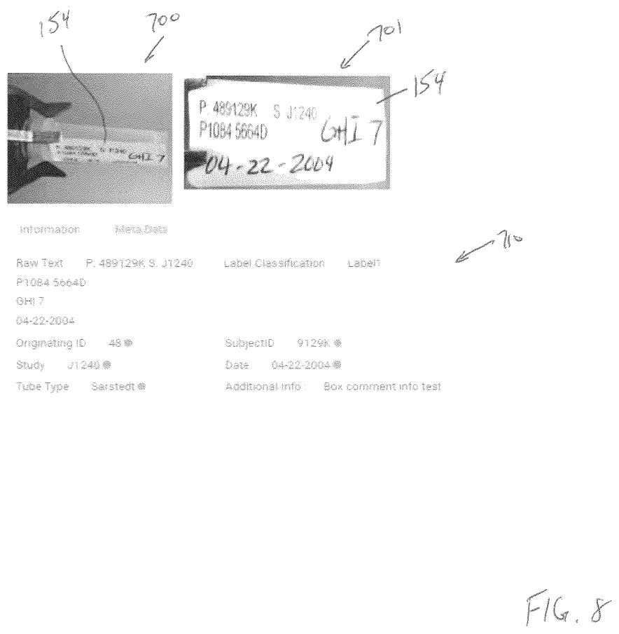

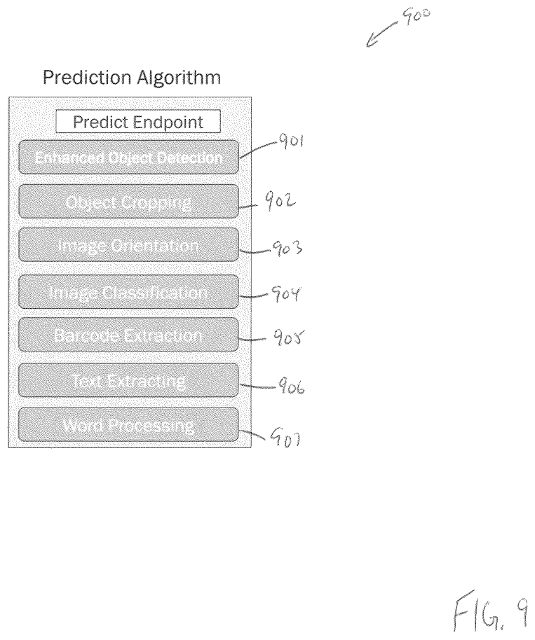

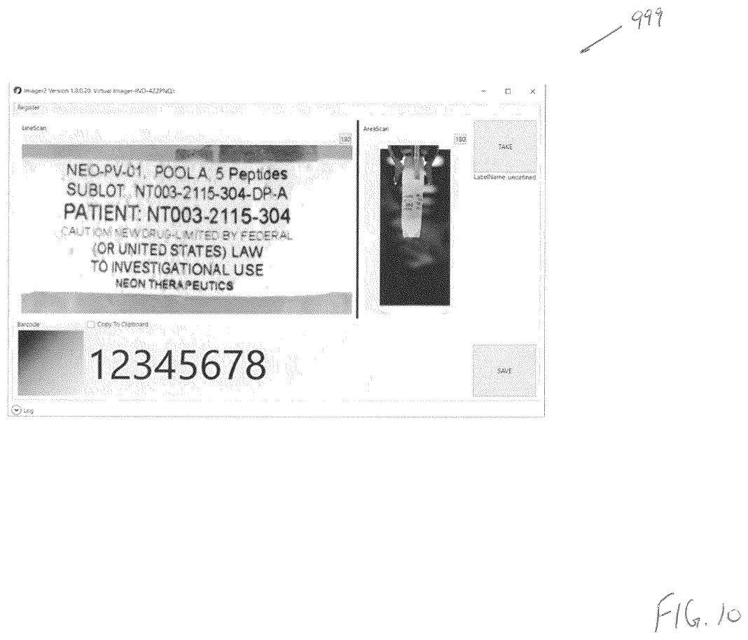

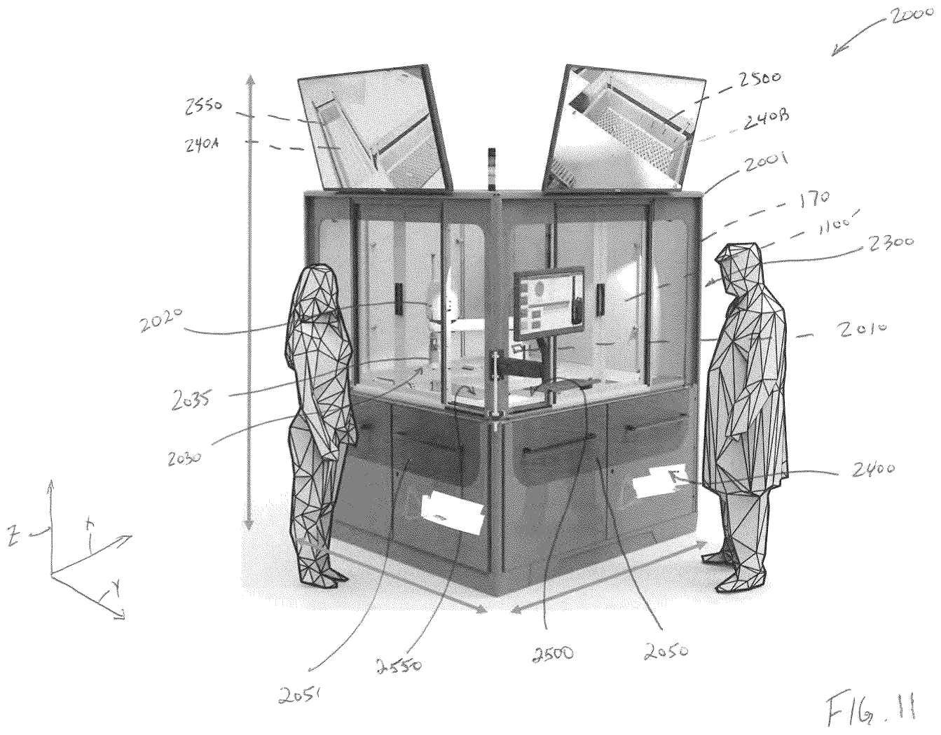

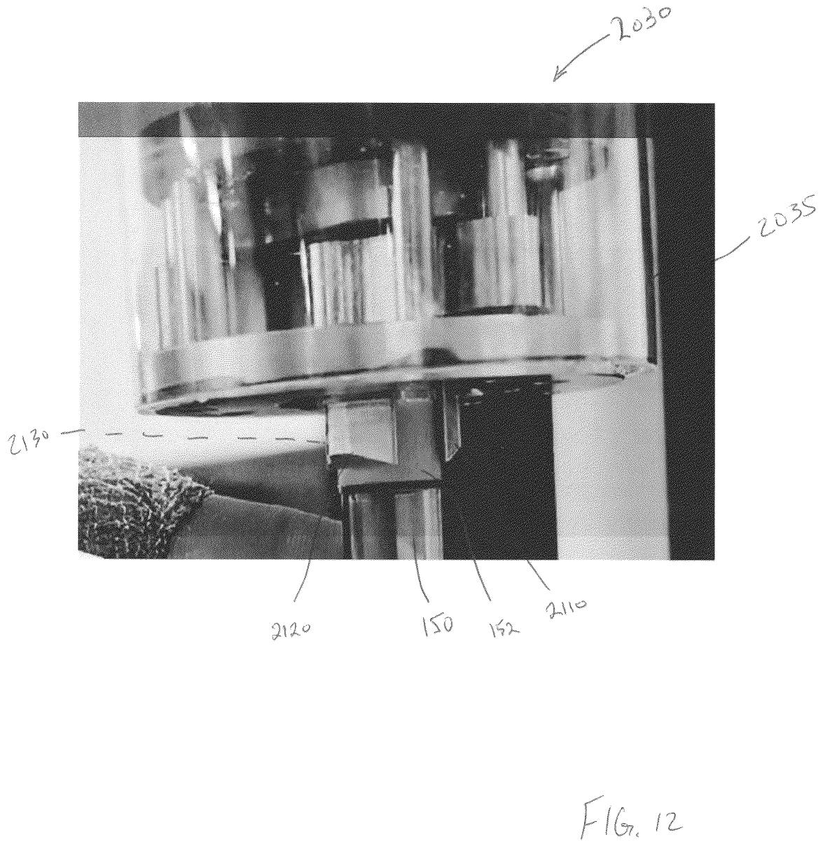

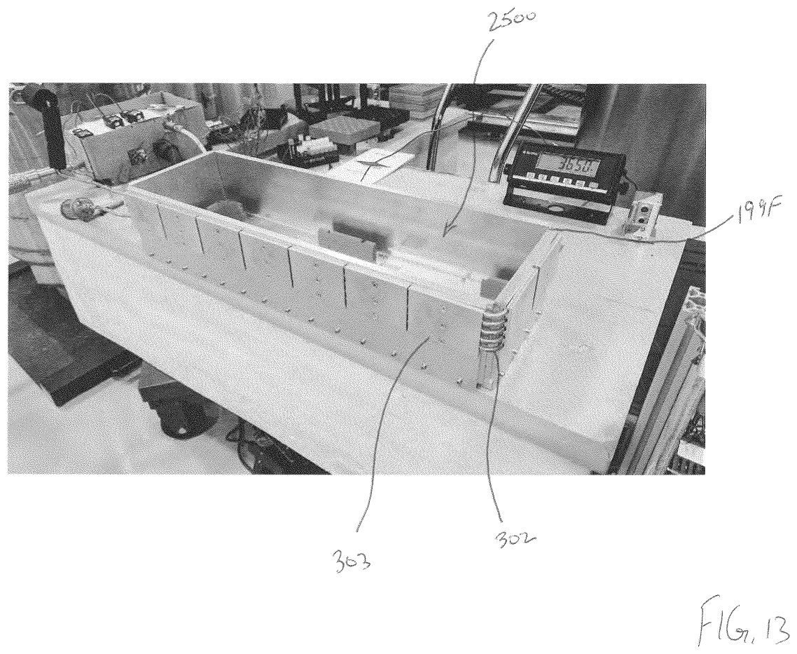

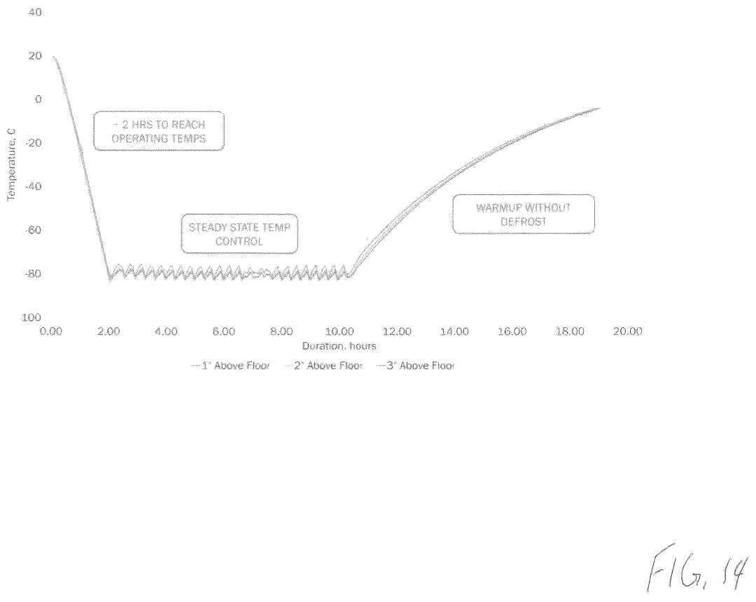

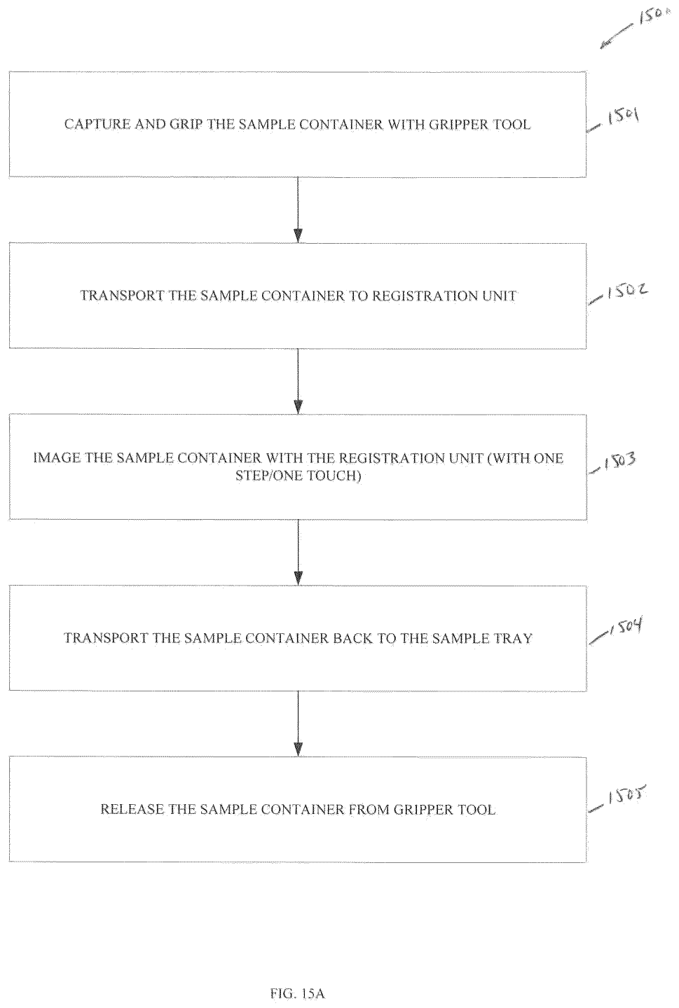

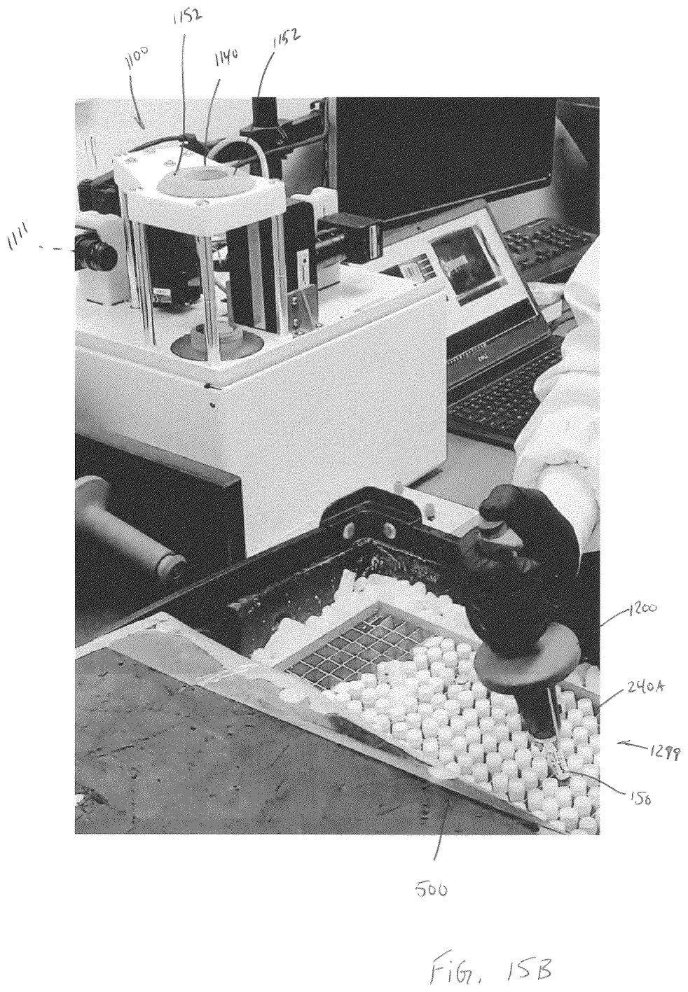

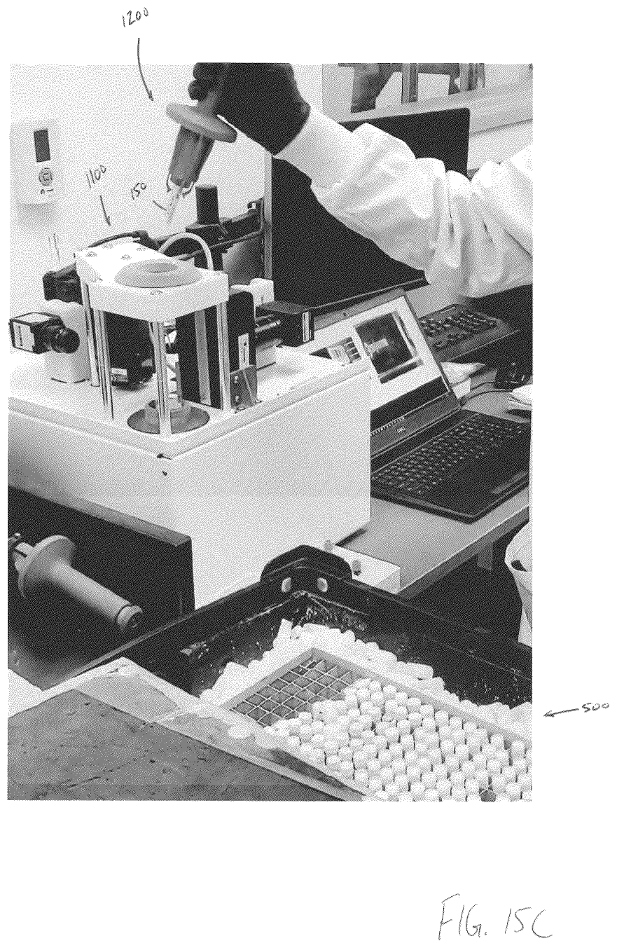

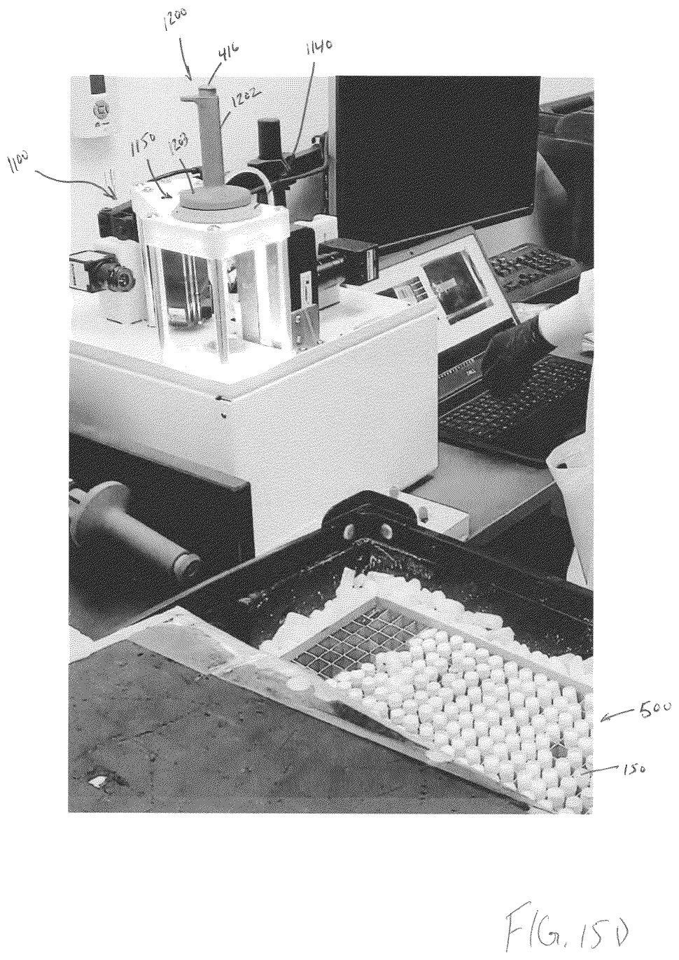

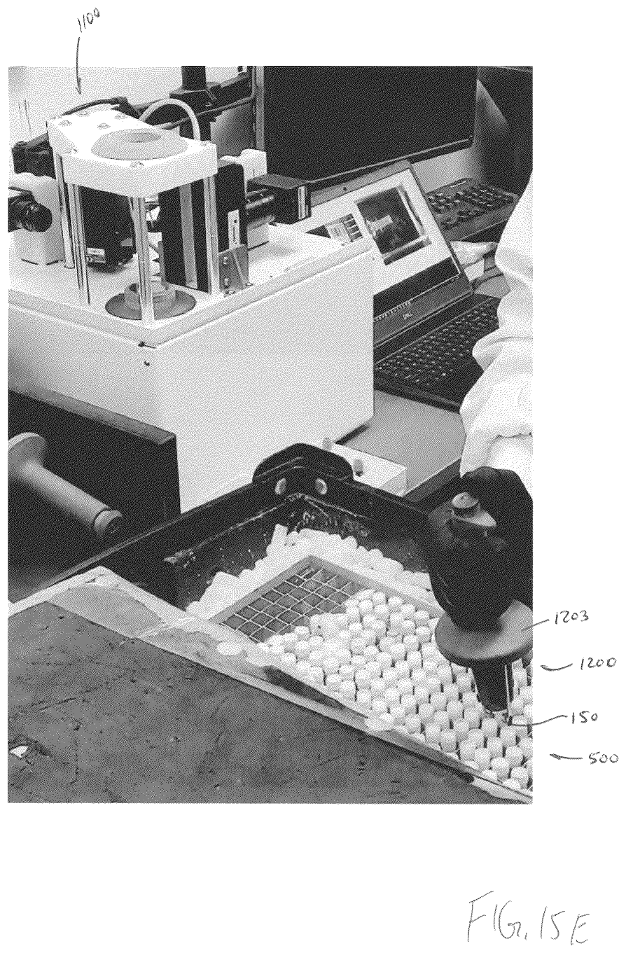

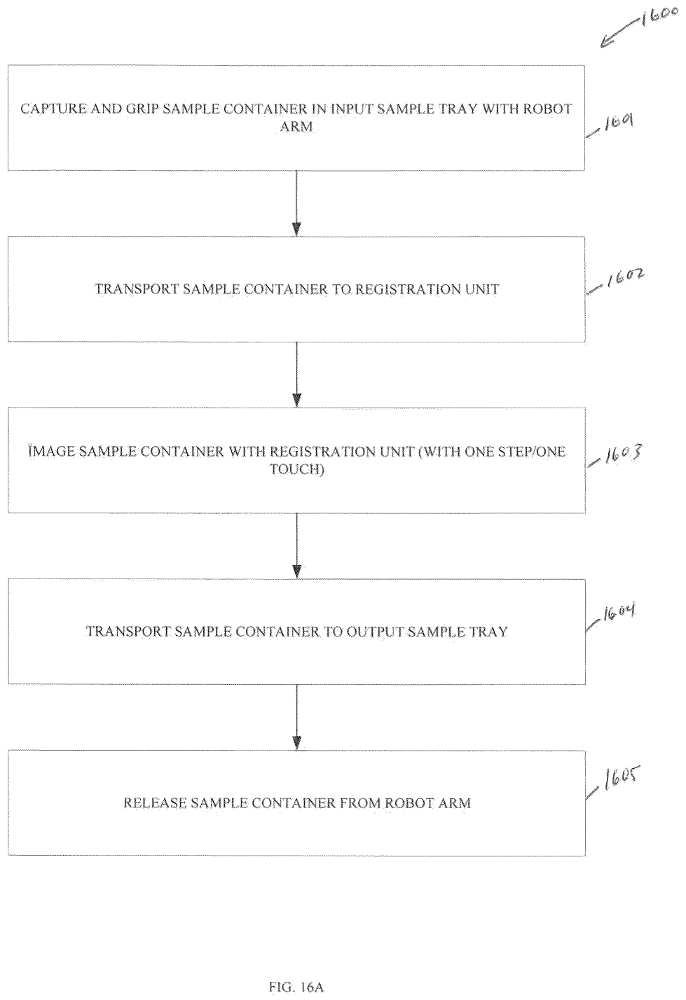

In one aspect, the laboratory 100 includes at least one of a semi-automated accessioning system 1000 and/or fully automated accessioning module 2000 for accessioning and registering samples disposed in samples containers 150. In one aspect, the accessioning system 1000/module 2000 may be configured to maintain specimens (e.g., biological samples or any other suitable samples) within sample containers 150 in an environment having any suitable temperature such as ambient/room temperature environments, cold environments (e.g., between −20 to −80° C.) and/or ultra-cold environments (e.g., at or below −80° C.) and cryogenic (e.g., at or below −150° C.). It is noted that the sample containers 150 described herein may be any suitable sample container having any suitable size such as, for example, 2 ml cryovials and/or 1.4 ml cryotubes. Accessioning and registration of sample containers 150 is accomplished via a one-touch (a single grip and release step of the sample container) capture of data provided on the sample container 150 (e.g., on a label affixed to the sample container), whether a characteristic of the sample container or information provided in alphanumerical form, a bar code, or any other human or machine readable indicia. The sample containers 150 are imaged, via one touch, in a quick and efficient manner such that the samples remain at a suitable temperature commensurate with the cold storage temperature appropriate for the sample with minimal effect from convective or conductive heat exchange (e.g., warming of the sample) as will be described below. The accessioning system 1000/module 2000 may include any suitable sample container infeed store station with a holding location/area 500 (FIG. 6) with a store array 240 configured for storing the sample containers 150 therein. The accessioning system 1000/module 2000 may further include any suitable transfer system (automated or manual) configured to transport one or more of the sample containers 150 between a registration tool 1100 of the system 1000/module 2000 that has a sample imager station 1100A and the storage or holding area 500. The registration tool 1100 is configured for both mechanical registration of the sample container 150 (either via a mechanical interface-semi-automatic or position/place at the sample imager station 1100A in robotic automation) and image data registration (via image and data registration to cloud-based system 999 (FIG. 10)) in one-step. The sample imager station 1100A has a machine vision system 1120 (FIG. 5) including at least one sensor 1110, 1111, 1112 being configured to generate a machine readable image 700, 701, 702 (FIG. 7) of each sample container 150 transported from the store array 240 with a transport device grip 1200, 2020 as will be further described below. The sample container 150 is held in the transport device automatic grip 1200, 2020 substantially continuously from sample container pick, at the store array 240, throughout imaging of the sample container 150 by the machine vision system 1120, wherein the transport device automatic grip 1200, 2020 holds the sample container 150 substantially coincident, at least in part, with imaging of the sample container 150 by the machine vision system 1120 so that generating the machine readable image 700, 701, 702 is effected in one grip step (or one touch from pick throughout imaging; one grip step or one touch may be used interchangeably throughout the description). For example, the semi-automated accessioning system 1000 may include any suitable sample imager station 1100A and a gripping tool 1200 configured to transport the sample container(s) 150 to and from the store array 240, to and from the sample imager station 1100A with one or more image capture devices and/or to and from the holding area 500. In one aspect, the automated accessioning module 2000 may at least include any suitable frame 2001, a drive section 2010 and a robot arm 2020 movably connected to the frame 2001. The drive section 2010 may be configured to move the robot arm 2020 along one or more axis (X, Y and/or Z axes, see, e.g., FIG. 11) for transporting the sample containers 150 to and from the store array 240, to and from the sample imager station 1100A′ and/or to and from the holding areas 2500, 2550 as will be described below. The laboratory 100 may include any suitable controller 170 to provide functionality for controlling the operations of the accessioning system 1000/module 2000 and the overall operation of the laboratory 100 as described herein.

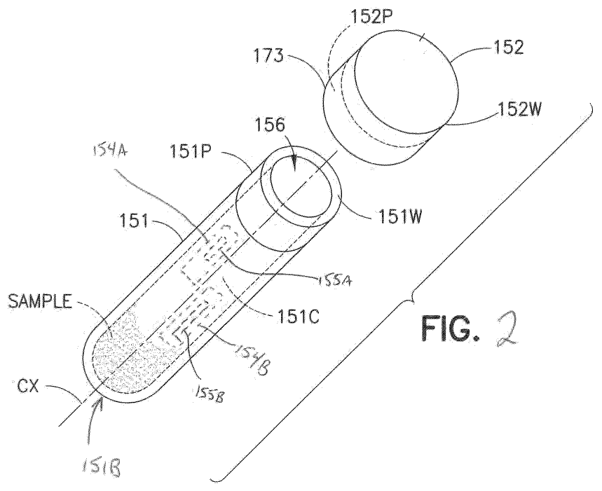

Referring to FIGS. 1 and 2, each of the sample containers 150 may include a sample holder 151, such as a test tube, and a cap 152 each of which may be constructed of any suitable materials. In one aspect, the tube and cap 152 may be constructed of any suitable plastic, glass filled plastic composite, rubber or any other suitable material. The sample holder 151 may include at least one peripheral wall 151W extending longitudinally along a central or longitudinal axis CX where the at least one peripheral wall 151W forms an opening 156 and a cavity 151C communicably connected to the opening 156. The at least one peripheral wall 151W may close the cavity 151C at one end so that the cavity 151C holds a sample(s) therein. Here the sample holder 151 is illustrated as having a cylindrical or test tube configuration but in other aspects, the sample holder 151 may have any suitable configuration with any suitable number of peripheral walls. The sample holder 151 may include any suitable cap engagement portion 151P. The cap 152 may have any suitable configuration for engaging the sample holder 151 and closing the opening 156. In one aspect, the cap 152 may have a cylindrical cap body 173 having at least one peripheral wall 152W defining the bounds within which the cap 152 (and hence the sample container 150) is gripped. In other aspects, the cap body 173 may have any suitable shape and or configuration. The cap 152 may include a sample holder engagement portion 152P configured to interface with the cap engagement portion 151P of the sample holder 151 for securing the cap 152 to the sample holder 151. In one aspect, the sample holder engagement portion 152P of the cap 152 may interface with the cap engagement portion 151P of the sample holder 151 in any suitable manner such that the cap 152 is retained on the sample holder 151 through a frictional engagement, a threaded engagement (e.g., male or female threading), a snap engagement, a magnetic engagement or in any other suitable manner. It should be understood that while the aspects of the disclosed embodiment are illustrated in the figures with respect to a cap 152 that surrounds or is placed over the top of the sample holder 151 (e.g., male tube interface/female cap interface), the sample holder 151 and cap 152 may have any suitable configuration for sealing the sample container.

The sample container 150 may include one or more of an identification section or lamina 154A, 154B with at least one or more respective identification indicia 155A, 155B thereon. The identification section 154A, 154B may be any suitable lamina, tag, label, etc. configured to actively or passively provide information, which may correspond to an identification of a sample within a respective sample container 150. The identification section 154A, 154B may be e.g., attached, coupled, etched or otherwise imprinted on any side of the sample container, such as the wall 151W of the sample container 150 and arranged for, e.g., identifying a respective sample container 150 and more particularly a characteristic of the sample therein. The identification indicia 155A, 155B may be one or more of any suitable bar code, data matrix at least of alphanumeric characters, machine generated or hand written. In one aspect, the bar code may be a linear barcode, two dimensional barcode, or any other suitable visual identifier that is machine readable and configured to identify and provide information about, for example, the sample within the sample container 150. In one aspect, the identification indicia 155B on identification section 154B may be of a different type than identification indicia 155A on identification section 154A.

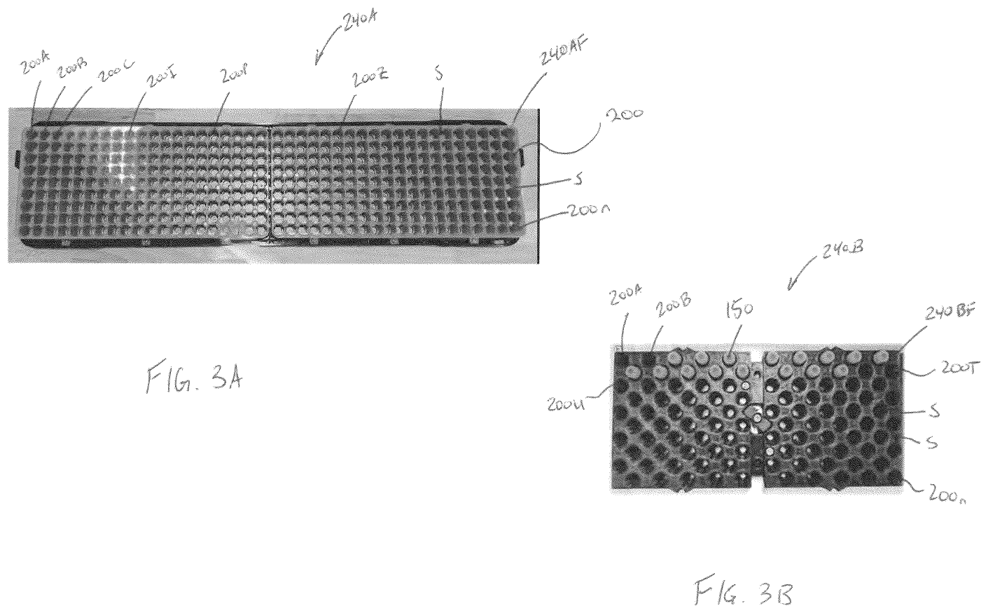

Referring to FIGS. 3A and 3B, the store array 240 may be any suitable container, tray, etc. with an array of sample container holding areas 200A, . . . 2001, 200J, . . . , 200 n (generally referred to as sample container holding area(s) 200). For example, the store array 240 may be an orthogonal sample tray 240A having a frame 240AF and a high-density array of sample container holding areas 200; while in other aspects, the store array 240 may be a honeycombed sample tray 240B having a frame 240BF and honeycombed array of sample container holding areas 200; in yet other aspect, the store array 240 may have any other suitable arrangement. The sample container holding areas 200 may have any suitable shape and configuration for stably holding the sample containers 150 within the sample tray 240A, 240B. In some aspects, such as illustrated in FIG. 3A with respect to tray 240A, the spacing S between the sample container holding areas 200 allows for a high-density or “closely packed” array of sample containers 150. Here, the space S may be such that the adjacent sample containers 150 (e.g., such as the peripheral walls 152W of the cap 152 or the peripheral walls 151W of the sample holder 151) are in substantial contact or have only minimal clearance between other adjacent sample containers 150 for allowing insertion and removal of the sample containers 150 to and from the sample tray 240A, 240B. In other aspects, such as with respect to tray 240B, the spacing S in not closely packed allowing more room for a gripper to retrieve the sample containers 150.

### Gripper

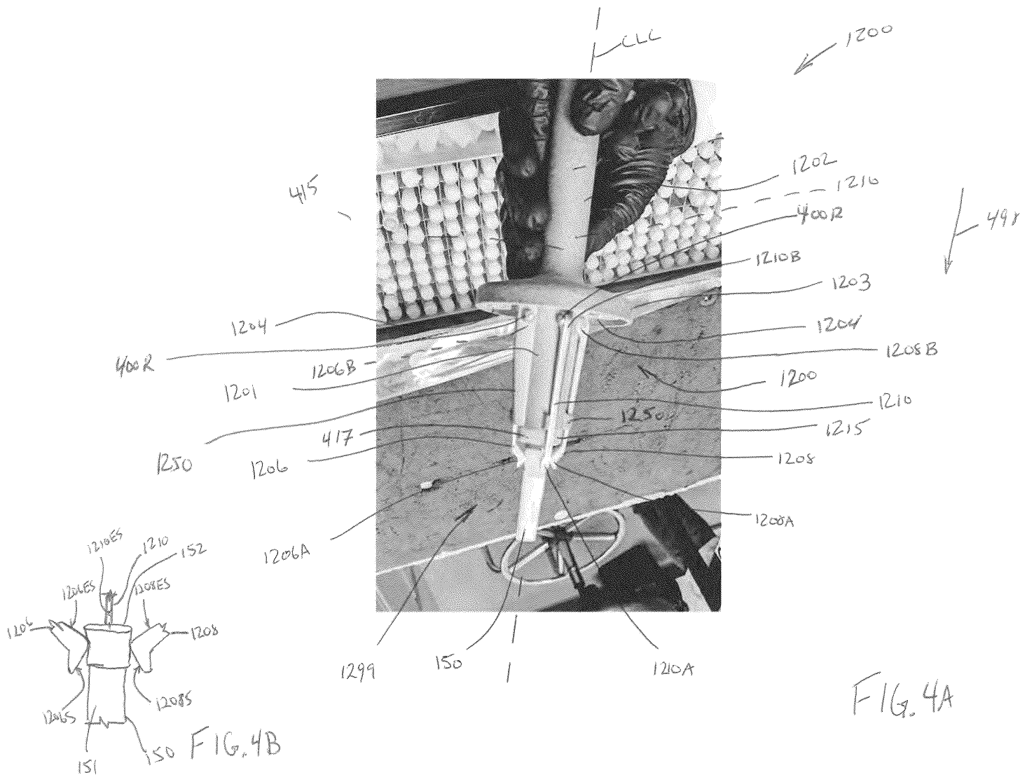

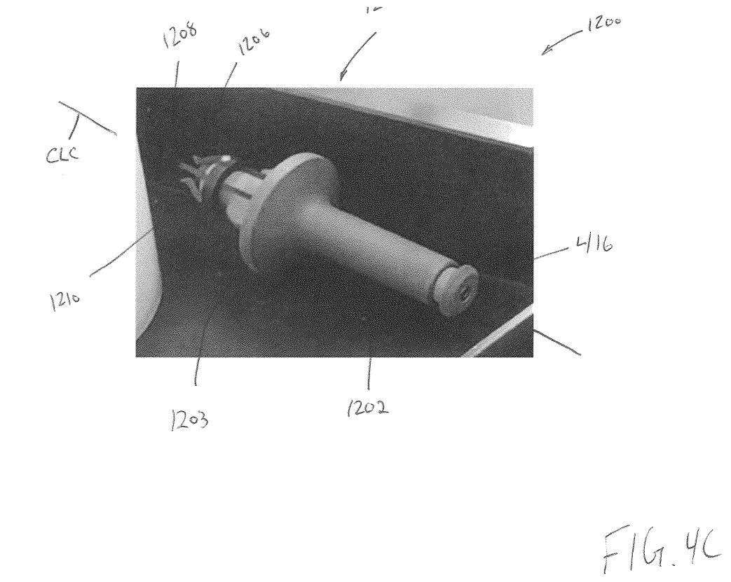

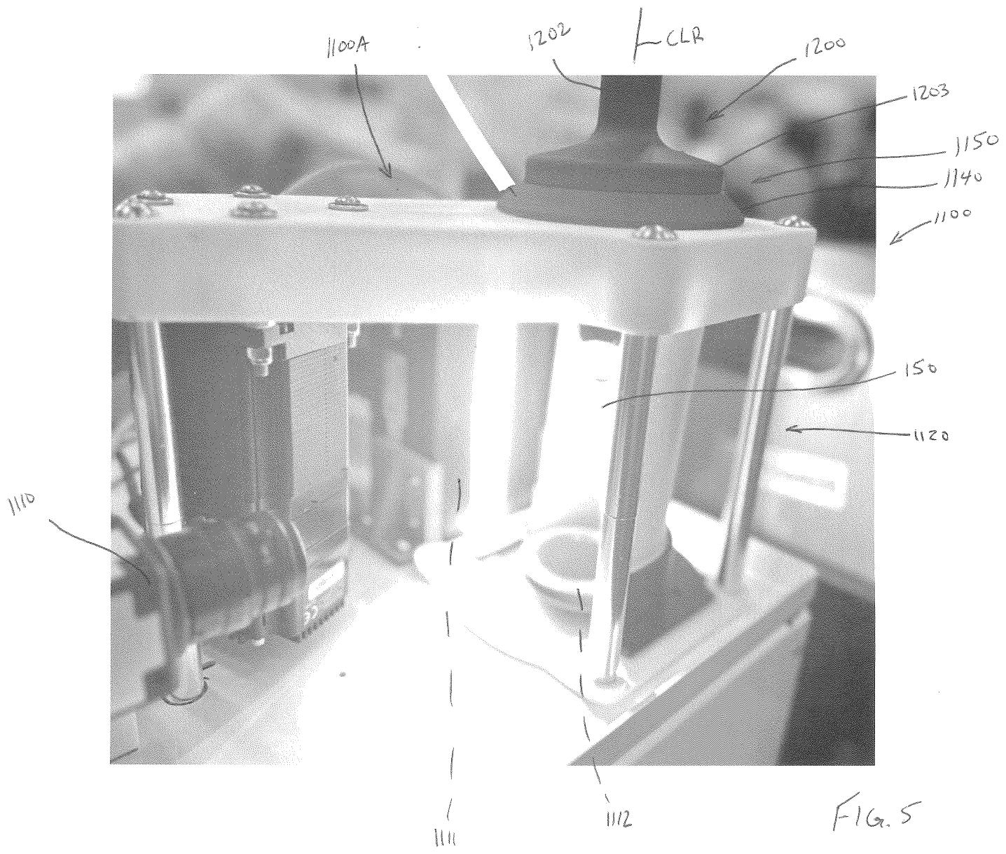

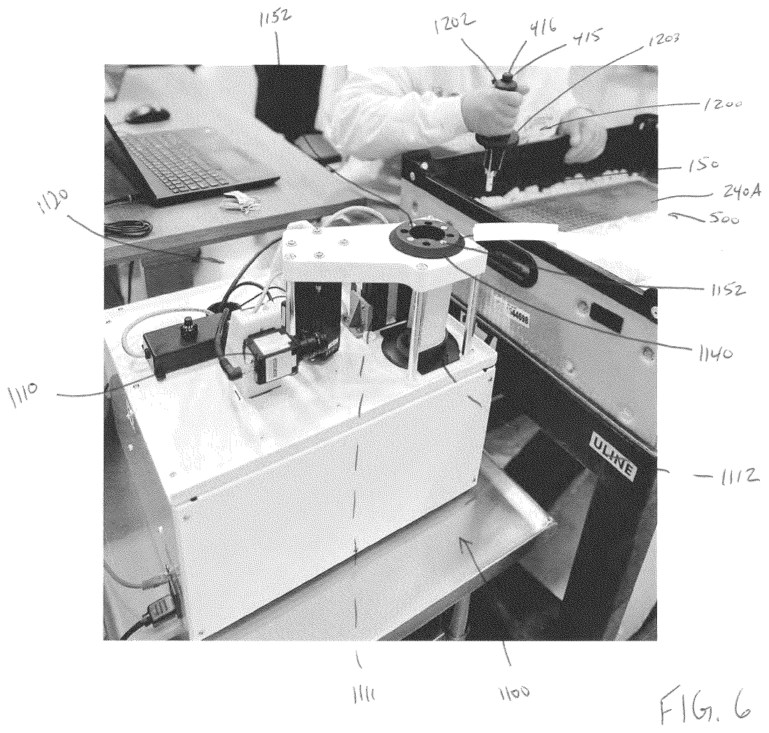

Referring now to FIGS. 1 and 4A-4B, the gripping tool 1200 is configured to transport the sample container(s) 150 between the sample trays 240A, 240B, and the sample imager station 1100A for imaging and capturing data from the sample container 150 (in order to register, record, audit and/or verify the data against a receiving manifest). The gripping tool 1200 is configured for a one-touch capture (at the sample tray 240A, 240B), transfer (to the sample imager station 1100A), imaging (at the sample imager station 1100A while gripped by the gripping tool 1200), return (to the sample tray 240A, 240B), and release (from grip by the gripping tool 1200) of the sample container 150. This one-touch capture, transfer, and registration process provides for a reduction in physical handling of the specimen, reduced registration time (the entire process takes about 7 seconds but could be more or less), improved sample integrity (less warming of the sample by multiple touches so sample temperature change through one touch imaging is minimal and sample temperature remains consistent with given samples appropriate cold storage temperature), etc. In some aspects, the gripping tool 1200 is configured to automatically grip the sample container 150 on contact with the sample container 150.

In one aspect, the gripping tool 1200 has a tubular configuration with a body 1201 (including a handle 1202), a registration tool engagement member 1203, and two or more flexible gripping members (here illustrated as three gripping members 1206, 1208, 1210) coupled to the body 1201 for gripping and transporting the sample container 150. Each gripping member 1206, 1208, 1210 may take a form of an elongated structure with a predetermined thickness that, in collaboration with one or more other gripping members 1206, 1208, 1210, are capable of gripping the sample container 150 or a portion of the sample container such as the cap 152. The gripping members 1206, 1208, 1210 are made from any suitable material that is bendable/flexible between a default/rest position 1298 (FIG. 4C) and a gripping position 1299 (FIG. 4A), such as thin flexible metal or any other suitable material. For example, with the gripping members 1206, 1208, 1210 not actively gripping a sample container 150, the gripping members 1206, 1208, 1210 are in the default position 1298 with a first end 1206A, 1208A, 1210A of each respective gripping members 1206, 1208, 1210 being positioned toward a centerline CLC of the gripping tool 1200 (e.g., in a generally “closed” configuration even though the gripping members 1206, 1208, 1210 may not necessarily touch). When gripping (i.e., in the gripping position with a sample container 150 therein), the sample container 150 is held in a fixed position between the first ends 1206A, 1208B, 1210A of the gripping members 1206, 1208, 1210. Here, the gripping members 1206, 1208, 1210 are flexed (due to forces exerted on the gripping members 1206, 1208, 1210 by the technician and the sample container 150) so as to be spread outwardly away from the centerline CLC. This spreading of the gripping members 1206, 1208, 1210 results in a passive, automatic capturing (and release as will be described below) of the sample container 150 where no active actuators or motors are utilized to grip the sample container 150 and the gripping relies on the elasticity and structure of the gripping members 1206, 1208, 1210 to automatically hold the sample containers 150.

Each gripping member 1206, 1208, 1210 is fixedly mounted (via a retention member 400R such as any suitable screw, bolt, rivet, etc.) at a second end 1206B, 1208B, 1210B of the gripping member 1206, 1208, 1210 to the body 1201. Fixedly mounting the second ends 1206B, 1208B, 1210B provides an anchor while allowing the first ends 1206A, 1208A, 1210A to flex and move. When the first ends 1206A, 1208A, 1210A of respective gripping members 1206, 1208, 1210 are deflected (via capturing of the sample container 150), the elasticity generates a restoring force that biases the first ends 1206A, 1208A, 1210A toward the centerline CLC. In other aspects, the material may be rigid and a torsion spring may be coupled to, e.g., the second ends 1206B, 1208B, 1210B of the gripping member 1206, 1208, 1210 to provide a biasing force to bias the first ends 1206A, 1208A, 1210A toward the centerline CLC.

As noted, the gripping members 1206, 1208, 1210, are configured to move outwards or away from each other relative to the centerline CLC of the gripping tool 1200 when interfacing with the sample containers 150. The first ends 1206A, 1208A, 1210A of the gripping members 1206, 1208, 1210 include ramp surfaces 1206S, 1208S, 1210S configured to engage, e.g., the cap 152 of the sample container 150, such that forces exerted by the technician with the gripping tool 1200 interfacing the cap 152 of the sample container 150, biases the gripping members 1206, 1208, 1210 away from the centerline CLC. The opposite side of the ramp surfaces may be configured to interface and shift adjacent sample containers 150 in the sample tray 240A (i.e., containers not being picked) away from the gripping members 1206, 1208, 1210 providing more room for the pick. In some aspects, the gripping tool 1200 contains one or more additional features, for example, ribbing 1250 on a peripheral wall of the body 1201 so as to limit deflection of the gripping members 1206, 1208, 1210.

The gripping tool 1200 may further include an ejector member 415 configured, at least in part, to disengage the sample container 150 from the gripping tool 1200. The ejector member 415 may be movable in the direction of arrow 498 relative to the gripping members 1206, 1208, 1210 so as to engage ejection surfaces 1206ES, 1208ES, 1210ES (FIG. 4B) of the gripping members 1206, 1208, 1210. The ejector member 415 engaging the ejection surfaces 1206ES, 1208ES, 1210ES biasing the first ends 1206A, 1208A, 1210A of the gripping members 1206, 1208, 1210 (passively gripping the sample container 150) further away from the centerline CLC to eject the sample container 150 from the gripping tool 1200. The ejector member 415 may be in the form of a push rod extending through the body 1201 of the gripping tool 1200 (where the body 1201 acts as a bushing or sleeve). The ejector member 415 extends through the body 1201 with a portion of one end 416 (FIG. 6) extending out of the handle 1202 of the body 1201 (defining a “push button”) and a portion of the other end 417 extending out of the body 1201 near the first ends 1206A, 1208A, 1210A of the gripping members 1206, 1208, 1210. A resilient element 1216 is disposed within the body and coupled to the ejector member 415 in order to bias the ejector member in direction 498 (i.e., the ejector member 415 is biased toward the handle 1202 of the body 1201 away from the first ends 1206A, 1208A, 1210A of the gripping members 1206, 1208, 1210). The other end 417 includes a radial extension 1215 that seats on the body 1201 to prevent retraction of the ejector member 415 through the body 1201 in direction 498. In order to release a gripped sample container 150, the “push button” is engaged by the technician, which operates to compress the resilient element 1216 and actuates the radial extension 1215 toward the ejection surfaces 1206ES, 1208ES, 1210ES of the gripping members 1206, 1208, 1210. The radial extension 1215 engages the ejection surfaces 1206ES, 1208ES, 1210ES and biases the first ends 1206A, 1208A, 1210A of the gripping members 1206, 1208, 1210 (gripping the sample container 150) further away from the centerline CLC to eject the sample container 150 from of the gripping tool 1200. Releasing the “push button” results in the resilient element 1216 biasing the ejector member 415 in direction 498 pulling the radial extension 1215 away from the first ends 1206A, 1208A, 1210A of the gripping members 1206, 1208, 1210 to return the gripping members 1206, 1208, 1210 to the default position 1298.

The registration tool engagement member 1203 includes a registration tool interface portion 1204, which is configured to couple to the sample imager station 1100A so that the registration tool engagement member 1203 is frangibly compliant as will be described below. The registration tool interface portion 1204 may be any suitable coupling such as a magnetic coupling, shear pins, etc.

### Registration Tool

Referring now to FIGS. 1 and 5-6, the sample imager station 1100A may be configured to image information displayed on the sample container 150, which information describing a predetermined characteristic of the particular sample container 150 in each respective one of the sample containers 150 that may be fed into a sample registration (e.g., cloud-based system 999 (FIG. 10)) for efficient processing of samples. As noted above, typically a sample container 150 has a volume of fluid or other biological material, the characteristics of which are sought for registration. The sample container 150 may include the identification section 154A, 154B with respective identification indicia 155A, 155B indicating relevant data describing characteristics of, and that may be unique to the sample and including process order information that has been submitted for that sample. Such data may be provided in alphanumeric form, whether hand written or typed, or provided in machine-readable code, such as a linear or two-dimensional bar code. The laboratory 100 typically handles a large volume of sample containers 150 that arrive at the laboratory 100 in sample trays 240A, 240B. The sample containers 150 must be systematically documented and managed to ensure proper processing and/or storage. The creation of an electronic register includes scanning or imaging of the sample containers 150 including the identification section 154A, 154B and identification indicia 155A, 155B thereon with the sample imager station 1100A, which is registered in the sample registration cloud-based system 999.

In one aspect, the sample imager station 1100A has a frame 1101 having a gripper engagement portion 1140, a machine vision system 1120, and at least one sensor 1110, 1111, 1112. The at least one sensor 1110, 1111, 1112 may be any suitable sensor, such as 2D cameras, CMOS color cameras, line scan cameras, a combination of cameras and mirrors, or any other suitable device for at least imaging sample source data of the specimen (sample container type, label type and data, indicia, etc.).

The at least one sensor 1110, 1111, 1112 may be positioned to scan any portion of the sample container 150, such as the walls 151W, cap 152, or bottom 151B. For example, a line scan camera may be positioned to image the perimeter of the wall 151W, while a barcode reader may be positioned to image the bottom 151B (any configuration of cameras and/or mirrors may be utilized to scan the portions of the sample container 150). The at least one sensor 1110, 1111, 1112 is configured to scan or otherwise image the identification indicia embodying the information (at least sample source data) from the sample container 150 for the sample registration cloud-based system 999 to determine the information describing characteristics such as origin data of the specimen of the sample container 150, storage location, storage position within tray/storage tool, tube type, and any other details relevant to the sample, etc. (see, example images 700, 701, 702 in FIGS. 7 and 8). Capturing characteristics of the sample container 150 includes generating machine-readable images (whether color or not) of the identification section 154A, 154B, the indicia 155A, 155B, the walls 151W the cap 152, and a bottom 151B (FIG. 2) of the sample container 150. In some aspects, the sensors may be used to capture various other dimensions of the sample container 150 (e.g., diameter, length, etc.), the color of the holder 151 or cap 152, volume of the specimen contained in the sample container 150, etc. In order to capture the data, the sample container 150 held by the gripping tool 1200 is inserted into the gripper engagement portion 1140 of the sample imager station 1100A. The gripper engagement portion 1140 is configured to spin so as to rotate the sample container 150 about axis CLR so that the machine vision system 1120 images (one touch) an entire exterior of the sample container 150 and each identification section 154A, 154B and identification indicia 155A, 155B. Machine vision sensors 1110, 1111, 1112 image each identification section 154A, 154B on the entire perimeter unconstrained by variances in placement and position, orientation of identification sections on the container exterior. Accordingly, each identification section is imaged on each sample container 150, the identification section 154A, 154B being disposed with stochastic variances in position, orientation on the sample container 150. Orientation of the sample container 150 placed in the frame 1101 with the gripping tool 1200 undeterministic (may be freely or oriented). The Machine vision system 1120 may also image the contents of the sample container 150, and may identify features such as meniscus and fractionated portions. As each sample container 150 rotates, the sample container 150 is imaged by the machine vision system 1120. The machine-readable images are generated with a one-grip step via the machine image system 1120. The generation of the machine-readable images is effected temporally (in a time period) consistent (or commensurate) with maintaining of thermal control of the sample corresponding to cold storage of the sample in the sample container 150. For example, in some aspects, the rotation and imaging takes about 2 second, while in other aspects, it may take more or less than 2 second. It is noted that the sample imager station 1100A may be a room temperature or at about-OC. Even if the sample being imaged is intended to be maintained at a lower temperature, the process of capture, image, and return is completed in a quick and efficient manner (in some aspects about 7 second; while in other aspects more or less than 7 seconds) and results in minimal to no change in temperature of the sample (i.e., the sample integrity is not degraded). From the imaged sample container 150, a record is created and maintained in the sample registration cloud-based system 999, or may be stored temporarily in any type of memory for the purpose of validating each sample container 150 at a later time.

As noted above, the registration tool engagement member 1203 of the gripping tool 1200 is configured to couple to the sample imager station 1100A so that the registration tool engagement member 1203 is frangibly compliant. Specifically, the registration tool engagement member 1203 is configured to couple to the gripper engagement portion 1140 via a frangible compliant coupling 1150 between the registration tool engagement member 1203 and the gripper engagement portion 1140. The frangible compliant coupling 1150 is configured to couple the gripping tool 1200 to the gripper engagement portion 1140, with the gripping tool 1200 and gripper engagement portion 1140 freely oriented with respect to each other, with for example complementing magnetic coupling elements that auto lock to each other when proximate to effect freely orientable coupling. Each coupling remains rigid until a frangible yielding reaction in a snap on engagement interface of the frangible compliant coupling 1150 breaks away (with resultant break away of the registration tool engagement member 1203 from the gripper engagement portion 1140) at a predetermined torque threshold. As will be described herein, at the predetermined torque threshold, the registration tool engagement member 1203 breaks away from the gripper engagement portion 1140. In one aspect, the yield or breaking/separation point/torque to break the registration tool engagement member 1203 from the gripper engagement portion 1140 may depend on the manner in which the registration tool engagement member 1203 is coupled to the gripper engagement portion 1140. In one aspect, the frangible compliant coupling 1150 is configured to provide a predetermined holding force for gripping the gripping tool 1200 where the yield force to separate the registration tool engagement member 1203 from the gripper engagement portion 1140 is suitable for substantially preventing undesired force or torque being imparted to the technician from the sample imager station 1100A (via the gripping of the gripping tool 1200) during operation of the sample imager station 1100A (i.e., the frangible compliant coupling 1150 breaks away so that the gripping tool 1200 is not rotated with the gripper engagement portion 1140). The frangible compliant coupling 1150 may also be configured to align (such as within field of view, and suitable distance) the gripping tool 1200 with the machine vision system 1120 of the sample imager station 1100A as described herein. As may be realized, since the registration tool engagement member 1203 is frangibly coupled to the sample imager station 1100A, the positioning of the registration tool engagement member 1203 is controlled to ensure that the gripper fingers 1206, 1208, 1210, grip the sample container 150 in a predetermined position.

Still referring to FIGS. 5 and 6, the frangible compliant coupling 1150 includes the gripper engagement portion 1140 and a grip interface portion 1152 that provides, e.g., a magnetic coupling for coupling to the registration tool interface portion 1204 on the registration tool engagement member 1203. In other aspects, any suitable coupling may be provided between the grip interface portion 1152 and the registration tool interface portion 1204 such as, for example, shear pins, adhesives, etc. In one aspect, grip interface portion 1152 of the frangible compliant coupling 1150 includes/is provided with deterministic features, as described herein, that define a snap on/off (auto lock) engagement interface mating with complementing features of the registration tool engagement member 1203 (where a snap on reattachment is provided as an automatic coupling interface engagement where the coupling interface engagement and alignment of the registration tool engagement member 1203 is performed in substantially one step). With the gripping tool 1200 is coupled to the sample imager station 1100A (via the frangible compliant coupling 1150), the gripper engagement portion 1140 is configured to rotate the gripping tool 1200 (gripping the sample container 150) in order to scan/image the sample container 150 with the machine vision system 1120. The machine vision system 1120 may be communicably coupled to the controller 170. The controller 170, communicably coupled to the machine vision system 1120, effects registration of the machine readable images 700, 701, 702 of the sample container 150 generated by the machine vision system 1120,

The memory may be coupled to a processor internally or externally (e.g., cloud based data storage) and may comprise any combination of volatile and/or non-volatile memory such as, for example, buffer memory, RAM, DRAM, ROM, flash, or any other suitable memory device. In some embodiments, the memory may be in the form of a computer readable medium (CRM), and may comprise code, executable by the processor for implementing methods described herein. In some embodiments, the processor may be part of a computer system including elements such as a keyboard, a mouse input device, memory comprising computer readable media, monitor and others. The computer apparatus may connect to a wide area network such as the Internet or cloud based data storage. Any servers, processors, or databases, may be present within the computer system and may use any suitable number of subsystems to facilitate the functions described herein, such as, e.g., functions for operating and/or controlling the functional units and modules of the laboratory automation system.

### Cloud-Based System

Referring to FIGS. 7-10, the controller 170 is communicably coupled to a sample registration cloud-based system 999, effecting registering data describing predetermined characteristics of the sample in the sample container 150, which data being defined by predetermined indicia, disposed on the sample container 150 in an orientation and/or position with stochastic variance, and embodied in the registered machine readable image 700, 701, 702. The sample registration cloud-based system 999 may include any suitable machine learning software. The machine learning software may be configured to read and enter label data elements into a register (see for example, label data 710 generated by the sample registration cloud-based system 999 in FIG. 7). The generation of label data may be accomplished via a training and learning algorithm, which functions and performs operations such as Enhanced Object Detection 901, Object Cropping 902, Image Orientation 903, Image Classification 904, Barcode Extraction 905, Text Extracting 906, and Word Processing 907. Over time, the training and learning algorithm learns to detect stochastic variances in position, orientation, size, etc. of labels and indicia so as to read and discern the raw text for registering. In some aspect, such as when the at least one sensor 1110, 1111, 1112, includes a line scan camera, the machine learning software may be provided to unwrap or flatten the line scan images. The machine learning software may also be configured to determine the identification section 154A, 154B orientation, type (e.g., 24 different types of labels with stochastic variations in orientation, position, size, etc.) or size and characterize the data embodied within (such as typed or hand written characters on the label). The embodied data may include headings or identifiers in raw text (coded (cipher) or not) that classify the type of data and the sample registration cloud-based system 999 converts the raw text into register data to determine the correct fields to place the data. The machine learning software may process, e.g., 10K sample per about 15 hours (could be more or less). The machine learning software has the ability to read a variety of labels and to verify the data against a receiving manifest.

### Robot Module

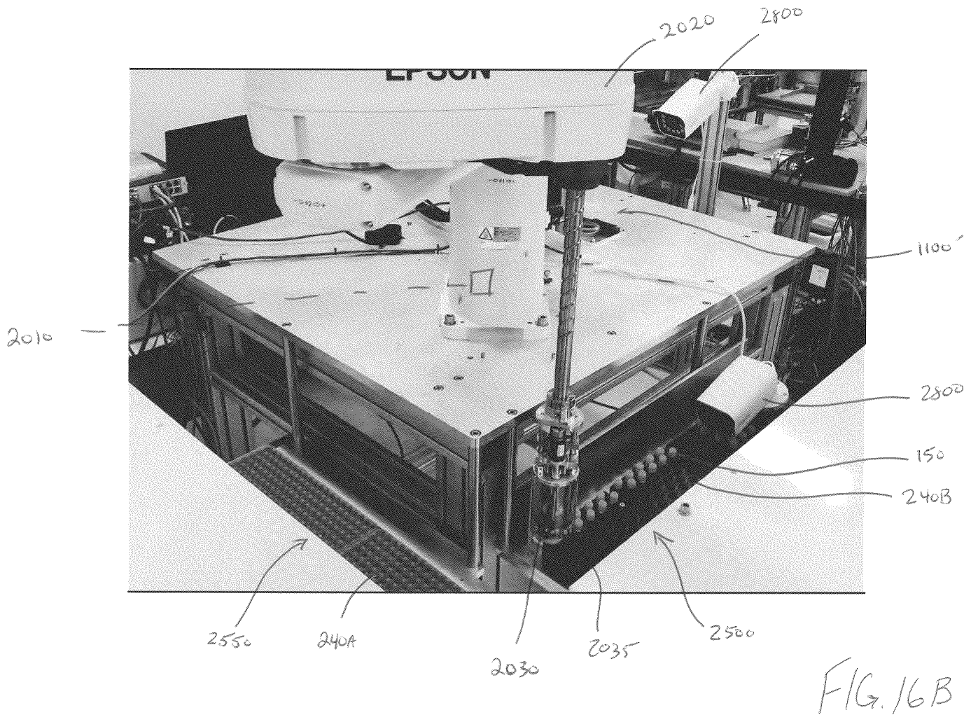

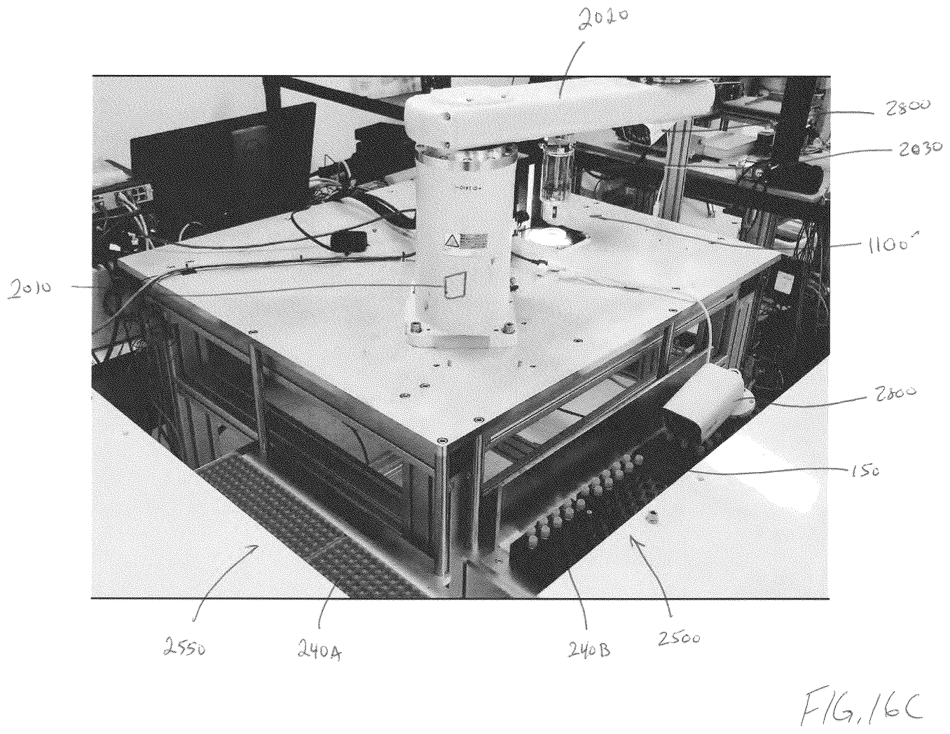

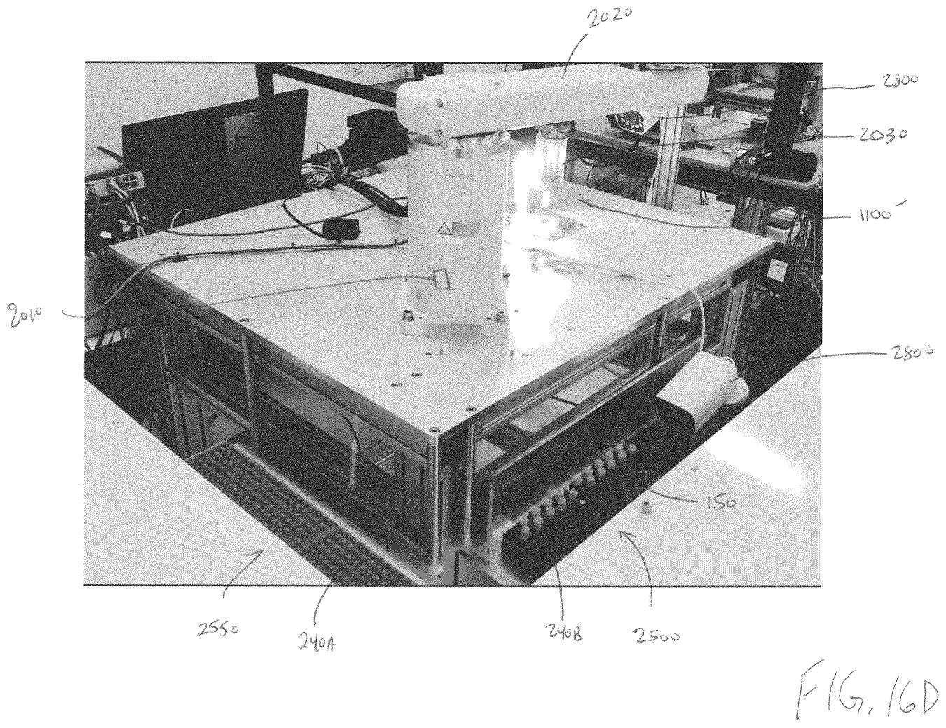

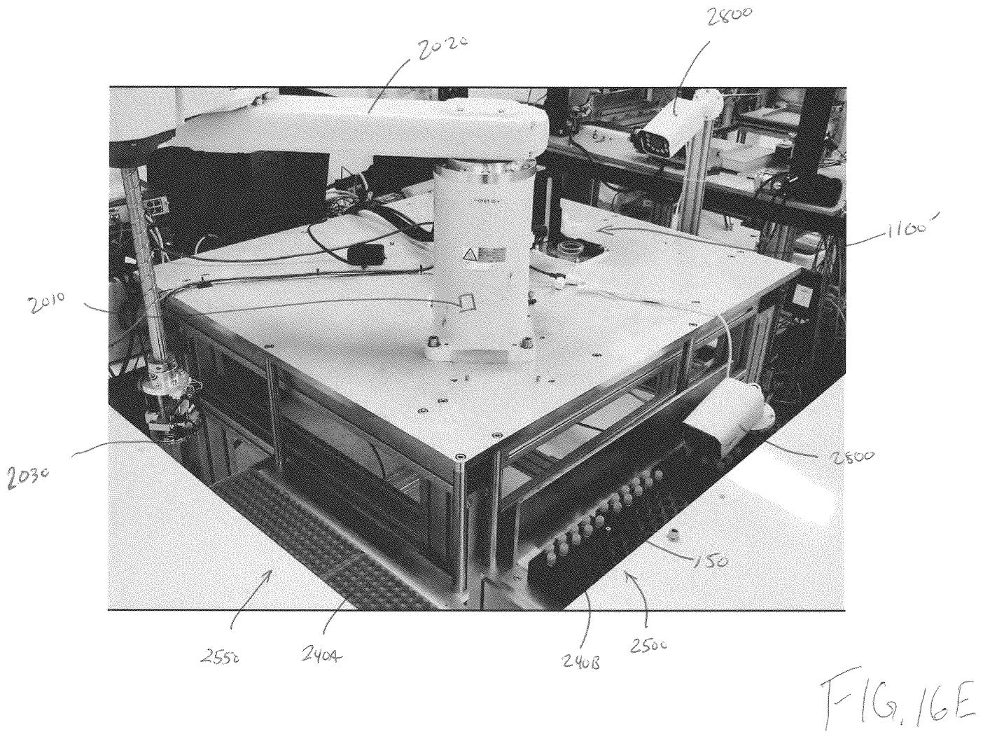

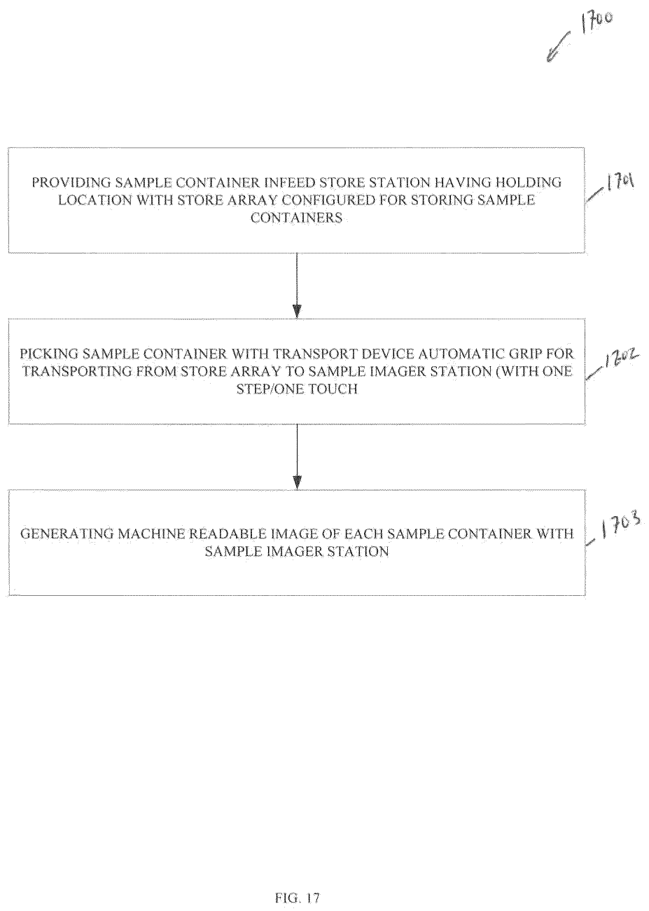

Referring now to FIGS. 11-14, in some aspects of the embodiment, capturing of the data of the sample containers 150 to register is completed by the automated accessioning module 2000. The automated accessioning module 2000 includes the frame 2001 having a transport space 2300 (including, at least the robot arm 2020, the drive section 2010 and sample imager station 1100A′) and a storage space 2400 (including, at least holding areas 2500, 2550). The transport space 2300 may have an environment that is ambient or at about 0° C. The robot arm 2020 is disposed in the transport space 2300 and operatively connected to the drive section 2010. The drive section 2010 is configured to move the robot arm 2020 (and thus gripper 2030) along one or more axis (X, Y and/or Z axes) for capturing and transporting the sample containers 150 from, e.g., the sample tray 240B (input) to sample imager station 1100A′ to sample tray 240A (output). The robot arm 2020 may be a SCARA arm, a gantry robot, or any other suitable robot arm for transporting the sample containers 150. As illustrated in FIG. 12, the automated accessioning module 2000 may utilize the robot arm 2020 to grip a sample container 150 (e.g., sample tube) using a gripper 2030 having gripper fingers 2110, 2120, 2130. The drive section 2010 is configured to actuate the gripper fingers 2110, 2120, 2130 between an open and close position for gripping the sample containers 150. In one embodiment, the robot arm 2020 may grip the sample container 150 using the gripper fingers 2110, 2120, 2130 from an input sample tray 2500, 240B, transport the container 150 to sample imager station 1100A′ for imaging, and deposits the container 150 to an output sample tray 2550, 240A. The gripper 2030 may include an isolation barrier 2035 for isolating the sample container 150 (gripped on the gripper 2030 being transported through the transport space 2300) from the ambient environment of the transport space 2300. The transport space 2300 may further include a positioning system 2800 (FIG. 16B), such as robot positioning cameras calibrated to identify positions of the sample trays 240A, 240B and the sample imager station 1100A′. One or more sensors coupled to the sample imager station 1100A′ captures the various characteristics associated with the sample container 150 (e.g., dimensions, weight, presence, type, etc.) while the sample container 150 is gripped by the gripper fingers 2110, 2120, 2130. The sample imager station 1100A may be substantially similar to the sample imager station 1100A described with respect to the manual accessioning system 1000 except as otherwise described. In the sample imager station 1100A′, the robot arm 2020 hold the sample container 150 with the gripper 2030, and the drive section 2010 has a drive axis (or motor shaft) that rotates the gripper 2030 so as to rotate the sample container 150 imaged by the machine vision system 1120. Further, the robot arm 2020 and the sample imager station 1100A′ may be communicatively coupled to the controller 170. The controller 170 may include a processor and a memory. The processor may further include a programmable logic controller (PLC). In some aspects, the processor may include other suitable processing elements (not shown), such as a microprocessor, a microcontroller, etc. The processor may be configured to execute instructions or code in order to implement methods, processes or operations of the disclosed embodiment. In some aspects, the processor may be configured to receive various outputs provided by different sensors that may be associated with the sample imager station 1100A′ communicatively coupled to the processor.

The storage module 2400 includes the holding areas 2500, 2550. The holding areas 2500, 2550 may be in the form of temperature controlled wells (FIG. 13). The wells include a frame 199F and one or more of insulation 303 and a thermal sink 302. The thermal sink 301 forms a temperature control with the insulated wall 303 in the automated accessioning module 2000 using, for example, metered liquid nitrogen (LN2). The thermal sink may be any suitable thermal sink, such as, for example, a heat exchanger where the LN2 flows through the heat exchanger (there is no pooling of LN2). In other aspects, any suitable refrigerant may be used to control temperature of the wells. In yet another aspect, the thermal sink 302 may be a cascade system to maintain temperature in the wells. As described herein, the frame 199F and thermal sink 301 provide the well with a predetermined thermal characteristic to maintain the temperature of the samples (whether at −20° C., −80° C., −190, or any other temperature). The holding areas 2500, 2550 hold the sample trays 240A, 240B and the sample containers 150 when not being registered by the sample imager station 1100A′. An isolation barrier may be provided to ensure cold air remains substantially in the well so that the ambient air of the transport space 2300 is substantially isolated from the cold air. It is noted that the storage module 2400 may further include a number of other units. For example, the automated accessioning module 2000 may include an input module 2050, a storage module (not shown), an output module 2051, etc. The arrangement of the (input tray 240B), holding area 2500 and holding area 2550 (output tray 240A), robot 2020 and sample imager station illustrated in FIG. 11 is exemplary. In other aspects, the relative position of holding areas 2500, 2550 may be reversed relative to each other, and with respect to the robot arm and sample imaging station for the minimum transport and one touch imaging of the sample container 150. As noted before, the input sample tray 240B has storage spaces not closely packed for each of grip capture of a sample container 150. The output tray 240A is closely packed, the gripper 2030 releases the sample container 150 from a position/height for non-interface with adjacent containers.

Referring now to FIGS. 15A-15E, a picking/scanning/placing operation 1500 of the semi-automated accessioning system 1000 fully automated accessioning module 2000 will be described. The technician positions the gripping tool 1200 above a predetermined sample container 150 disposed within, for example, a sample tray 240A, 240B or any other suitable sample container holding area 500. In one aspect, the technician may identify the predetermined sample container 150 using one or more of the identification section 154A, 154B and the manifest provided by sample source data or in any other suitable manner. The gripping tool 1200 is moved to position the gripping members 1206, 1208, 1210 above the sample container 150 and to align the gripping members 1206, 1208, 1210 with, e.g., the cap 152 or any other feature of the sample container 150. The gripping members 1206, 1208, 1210 of the gripping tool 1200 are biased away from the centerline CLC by the cap 152 in order to capture and grip the sample container 150 in the gripping members 1206, 1208, 1210 of the gripping tool 1200 (FIG. 15A Block 1501).

Once the sample container 150 is gripped by the gripping tool 1200, the technician transfers the sample container 150 to the sample imager station 1100A (FIG. 15A, Block 1502). The technician couples the registration tool engagement member 1203 of the gripping tool 1200 to the gripper engagement portion 1140 of the sample imager station 1100A via the frangible compliant coupling 1150. The sample imager station 1100A auto detects the gripping tool 1200 and auto engages the rotation of the gripping tool 1200. Images are captured by the sample imager station 1100A, via the at least one sensor 1110, 1111, 1112, of the sample container 150 (FIG. 15A, Block 1503).

Once the sample container 150 is imaged by the registration tool 1100, the technician transfers the sample container 150 to the sample tray 240A, 240B (FIG. 15A, Block 1504) or to any other suitable sample container holding area. The sample container 150 is released into the sample tray 240A, 240B (FIG. 15A, Block 1505). The sample container may be positioned over a predetermined sample holding location, such as a sample container holding area 200 and placed into the holding area. In one aspect, the ejector member 415 may be employed to spread the gripping members 1206, 1208, 1210. For example, the ejector member 415 may be biased (in any suitable manner such as by the technician) in the direction of arrow 498 (FIG. 4A) and the gripping members 1206, 1208, 1210 may be biased in an open position. The ejector member 415 may include the radial extension 1215 that when positioned between the gripping members 1206, 1208, 1210 causes the extension or spreading of the gripping members 1206, 1208, 1210 away from the centerline CLC. As may be realized, the bias of the ejector member 415 in the direction of arrow 498 by the technician may position the radial extension 1215 relative the gripping members 1206, 1208, 1210 (e.g., so that the gripping members are spread) allows any sample container 150 held by the gripping tool 1200 to be ejected from the gripping tool 1200.

Referring now to FIGS. 16A-16E, a picking/scanning/placing operation 1600 of the fully automated accessioning module 2000 will be described. The controller 170 may position, using the drive section 2010, the robot arm 2020 (and gripper 2030) above a predetermined sample container 150 disposed within, for example, a sample tray 240B or any other suitable sample container holding area. In one aspect, the controller 170 may identify the predetermined sample container 150 using one or more of the identification section 154A, 154B and a manifest in a memory accessible by the controller or in any other suitable manner. The robot arm 2020 (and gripper 2030) is moved to position the gripper 2030 and to align the gripper fingers 2110, 2120, 2130 with, e.g., the cap 152 of the sample container 150. The gripper fingers 2110, 2120, 2130 are actuated by the drive section 2010 to engage and grip the sample container 150 (FIG. 16A Block 1601). In one aspect, the gripper fingers 2110, 2120, 2130 may be opened and closed by a respective portion of the drive section 2010 configured to move each of the gripping members. Once the sample container 150 is gripped by the robot arm 2020 (and gripper 2030) the controller 170 may cause, using the drive section 2010, the sample 150 to be picked from the sample container holding area 2500 and transferred to the sample imager station 1100A′ (FIG. 16A Block 1602). The gripper 2030 is controlled to rotate the sample container 150 so that the sample imager station 1100A′ images and captures the data on the sample container 150 (FIG. 16A Block 1603). Once the sample container 150 is imaged, the sample container is moved and positioned over a predetermined sample holding location at the output tray 2550 (FIG. 16A Block 1604), and placed into the sample tray 240A at the holding area 2550 (FIG. 16A Block 1605). The drive section 2010 may effect relative movement of the gripper fingers 2110, 2120, 2130 to open the gripper fingers 2110, 2120, 2130 and release the sample container 150.

Referring to FIG. 17, a method 1700 of registering samples disposed in sample containers 150. The method includes providing a sample container infeed store station having a holding location 500 with a store array 240 configured for storing the sample containers 150 therein (FIG. 17, Block 1701) The sample container is picked with the transport device automatic grip 1200 for transporting from the store array 240 to the sample imager station 1100A (FIG. 17, Block 1702). The sample imager station 1100A generates a machine readable image 700, 701, 702 of each sample container 150 (FIG. 17, Block 1703) transported from the store array 240, the sample container 150 being held in the transport device automatic grip 1200 substantially continuously from sample container pick, at the store array 240, throughout imaging of the sample container 150 by the sample imager station 1100A. The transport device automatic grip 1200 holds the sample container 150 substantially coincident, at least in part, with imaging of the sample container 150 by the sample imager station 1100A so that generating the machine readable image 700, 701, 702 is effected in one grip step from pick throughout imaging.

In accordance with one or more aspects of the present disclosure an automated sample registration system for registering samples disposed in sample containers or tubes is provided. The automated sample registration system including a sample container infeed store station having a holding location with a store array configured for storing the sample containers therein, and a sample imager station, with a machine vision system having at least one of a line scanner and a camera, the at least one of the line scanner and the camera being configured to generate a machine readable image of each sample container transported from the store array with a transport device automatic grip, the sample container being held in the transport device automatic grip substantially continuously from sample container pick, at the store array, throughout imaging of the sample container by the machine vision system, wherein the transport device automatic grip holds the sample container substantially coincident, at least in part, with imaging of the sample container by the machine vision system so that generating the machine readable image is effected in one grip step (from pick through imaging).

In accordance with one or more aspects of the present disclosure the generation of the machine readable image with one grip step via the machine image system is effected temporally (in a time period) consistent (or commensurate) with maintaining thermal control of the sample corresponding to cold storage of the sample in the sample container.

In accordance with one or more aspects of the present disclosure the automated sample registration system further including a controller communicably coupled to the machine vision system so as to register the machine readable image of the sample container generated by the machine vision system, and communicably coupled to a cloud data registration system, registering data describing predetermined characteristics of the sample in the sample container, which data being defined by predetermined indicia, disposed on the sample container in an orientation and/or position with stochastic variance, and embodied in the registered machine readable image.

In accordance with one or more aspects of the present disclosure the data is in alphanumeric form.

In accordance with one or more aspects of the present disclosure the data is in the form of a barcode.

In accordance with one or more aspects of the present disclosure the data is in the form of a cipher code.

In accordance with one or more aspects of the present disclosure the predetermined characteristics of the sample include one or more of sample information, specimen type, collection source, collection method, collection location, collection date, temperature requirements, and a batch or lot number.

In accordance with one or more aspects of the present disclosure the transport device automatic grip, effects gripping the sample container automatically on contact with the sample container.

In accordance with one or more aspects of the present disclosure a method of registering samples disposed in sample containers or tubes with an automated sample registration system. The method including providing a sample container infeed store station having a holding location with a store array configured for storing the sample containers therein, picking, with a transport device automatic grip, a sample container for transporting from the store array to a sample imager station, and generating, with the sample imager station having a machine vision system including at least one of a line scanner and a camera, a machine readable image of each sample container transported from the store array, the sample container being held in the transport device automatic grip substantially continuously from sample container pick, at the store array, throughout imaging of the sample container by the machine vision system, wherein the transport device automatic grip holds the sample container substantially coincident, at least in part, with imaging of the sample container by the machine vision system so that generating the machine readable image is effected in one grip step (from pick throughout imaging).

In accordance with one or more aspects of the present disclosure the generation of the machine readable image with one grip step via the machine image system is effected temporally (in a time period) consistent (or commensurate) with maintaining thermal control of the sample corresponding to cold storage of the sample in the sample container.

In accordance with one or more aspects of the present disclosure a controller is communicably coupled to the machine vision system and a cloud data registration system, the method further comprising registering the machine readable image of the sample container generated by the machine vision system and data describing predetermined characteristics of the sample in the sample container, which data being defined by predetermined indicia, disposed on the sample container in an orientation and/or position with stochastic variance, and embodied in the registered machine readable image.

In accordance with one or more aspects of the present disclosure the data is in alphanumeric form.

In accordance with one or more aspects of the present disclosure the data is in the form of a barcode.

In accordance with one or more aspects of the present disclosure the data is in the form of a cipher code.

In accordance with one or more aspects of the present disclosure the predetermined characteristics of the sample include one or more of patient information, specimen type, collection source, collection method, collection location, collection date, temperature requirements, and a batch or lot number

In accordance with one or more aspects of the present disclosure the method further including effecting gripping of the sample container with the transport device automatic grip automatically on contact with the sample container.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the present disclosure.

What is claimed is:

1. An automated sample registration system for registering samples disposed in sample containers or tubes, the automated sample registration system comprising:
a sample container infeed store station having a holding location with a store array configured for storing the sample containers therein; and
a sample imager station, with a machine vision system having at least one of a line scanner and a camera, the at least one of the line scanner and the camera being configured to generate a machine readable image of each sample container transported from the store array with a transport device automatic grip, the sample container being held in the transport device automatic grip substantially continuously from sample container pick, at the store array, throughout imaging of the sample container by the machine vision system;
wherein the transport device automatic grip holds the sample container substantially coincident, at least in part, with imaging of the sample container by the machine vision system so that generating the machine readable image is effected in one grip step.

2. The automated sample registration system of claim 1, wherein the generation of the machine readable image with one grip step via the machine image system is effected temporally, commensurate with maintaining thermal control of the sample corresponding to cold storage of the sample in the sample container.

3. The automated sample registration system of claim 1, further comprising a controller communicably coupled to the machine vision system so as to register the machine readable image of the sample container generated by the machine vision system, and communicably coupled to a cloud data registration system, registering data describing predetermined characteristics of the sample in the sample container, which data being defined by predetermined indicia, disposed on the sample container in an orientation and/or position with stochastic variance, and embodied in the registered machine readable image.

4. The automated sample registration system of claim 3, wherein the data is in alphanumeric form.

5. The automated sample registration system of claim 3, wherein the data is in the form of a barcode.

6. The automated sample registration system of claim 3, wherein the data is in the form of a cipher code.

7. The automated sample registration system of claim 3, wherein the predetermined characteristics of the sample include one or more of patient information, specimen type, collection source, collection method, collection location, collection date, temperature requirements, and a batch or lot number.

8. The automated sample registration system of claim 1, wherein the transport device automatic grip, effects gripping the sample container automatically on contact with the sample container.

9. A method of registering samples disposed in sample containers or tubes with an automated sample registration system, the method comprising:
providing a sample container infeed store station having a holding location with a store array configured for storing the sample containers therein;
picking, with a transport device automatic grip, a sample container for transporting from the store array to a sample imager station; and
generating, with the sample imager station having a machine vision system including at least one of a line scanner and a camera, a machine readable image of each sample container transported from the store array, the sample container being held in the transport device automatic grip substantially continuously from sample container pick, at the store array, throughout imaging of the sample container by the machine vision system;
wherein the transport device automatic grip holds the sample container substantially coincident, at least in part, with imaging of the sample container by the machine vision system so that generating the machine readable image is effected in one grip step.

10. The method of claim 9, wherein the generation of the machine readable image with one grip step via the machine image system is effected temporally commensurate with maintaining thermal control of the sample corresponding to cold storage of the sample in the sample container.

11. The method of claim 9, wherein a controller is communicably coupled to the machine vision system and a cloud data registration system, the method further comprising registering the machine readable image of the sample container generated by the machine vision system and data describing predetermined characteristics of the sample in the sample container, which data being defined by predetermined indicia, disposed on the sample container in an orientation and/or position with stochastic variance, and embodied in the registered machine readable image.

12. The method of claim 11, wherein the data is in alphanumeric form.

13. The method of claim 11, wherein the data is in the form of a barcode.

14. The method of claim 11, wherein the data is in the form of a cipher code.

15. The method of claim 11, wherein the predetermined characteristics of the sample include one or more of patient information, specimen type, collection source, collection method, collection location, collection date, temperature requirements, and a batch or lot number.

16. The method of claim 9, further comprising effecting gripping of the sample container with the transport device automatic grip automatically on contact with the sample container.
